(19) United States
(12) Patent Application Publication
(10) Pub. No.: US 2020/0007741 A1
(43) Pub. Date: Jan. 2, 2020

(54) DETECTION SYSTEM AND METHOD

(71) Applicant: GE Global Sourcing LLC, Norwalk, CT (US)

(72) Inventors: Debra Johnson, Niskayuna, NY (US); Chris Berger, Niskayuna, NY (US); Mark Bradshaw Kraeling, Melbourne, FL (US); Glen William Brooksby, Glenville, NY (US); Livia Bicalho, Atlanta, GA (US); Doug Vroman, Erie, PA (US)

(21) Appl. No.: 16/557,348

(22) Filed: Aug. 30, 2019

Related U.S. Application Data
(63) Continuation-in-part of application No. 15/913,434, filed on Mar. 6, 2018.
Application No. 15/913,434 is a continuation-in-part of application No. 16/136,423, filed on Sep. 20, 2018.
Application No. 16/136,423 is a division of application No. 14/541,370, filed on Nov. 14, 2014, now Pat. No. 10,110,795.
Application No. 14/541,370 is a continuation-in-part of application No. 14/217,672, filed on Mar. 18, 2014.
Application No. 14/217,672 is a continuation-in-part of application No. 14/253,294, filed on Apr. 15, 2014, now Pat. No. 9,875,414.
Application No. 14/253,294 is a continuation-in-part of application No. 14/457,353, filed on Aug. 12, 2014.
Application No. 14/457,353 is a continuation-in-part of application No. 14/479,847, filed on Sep. 8, 2014, now abandoned.
Application No. 14/479,847 is a continuation-in-part of application No. 14/485,398, filed on Sep. 12, 2014, now Pat. No. 10,049,298.
Application No. 14/485,398 is a continuation-in-part of application No. 13/109,209, filed on May 17, 2011, now Pat. No. 8,913,131.
Application No. 13/109,209 is a division of application No. 11/146,831, filed on Jun. 6, 2005, now Pat. No. 7,965,312.
Application No. 11/146,831 is a continuation-in-part of application No. 10/361,968, filed on Feb. 10, 2003, now abandoned.
Application No. 14/479,847 is a continuation-in-part of application No. 14/217,672, filed on Mar. 18, 2014.
(60) Provisional application No. 61/940,813, filed on Feb. 17, 2014.
(60) Provisional application No. 61/940,660, filed on Feb. 17, 2014.
(60) Provisional application No. 61/940,610, filed on Feb. 17, 2014.
(60) Provisional application No. 61/940,696, filed on Feb. 17, 2014.
(60) Provisional application No. 60/626,573, filed on Nov. 10, 2004.
(60) Provisional application No. 60/385,645, filed on Jun. 4, 2002.
(60) Provisional application No. 61/940,813, filed on Feb. 17, 2014.
(60) Provisional application No. 61/940,660, filed on Feb. 17, 2014.
(60) Provisional application No. 61/940,610, filed on Feb. 17, 2014.
(60) Provisional application No. 61/940,696, filed on Feb. 17, 2014.
(60) Provisional application No. 61/940,813, filed on Feb. 17, 2014.
(60) Provisional application No. 61/940,660, filed on Feb. 17, 2014.
(60) Provisional application No. 61/940,610, filed on Feb. 17, 2014.
(60) Provisional application No. 61/940,696, filed on Feb. 17, 2014.

(51) Int. Cl. H04N 5/232; B60R 1/00

(52) U.S. Cl. CPC H04N 5/23203; H04N 7/185; H04N 5/23206; B60R 1/002

(57) ABSTRACT

A device for detecting proximity to an active alternating current (AC) voltage source is provided. The device includes a housing, at least one antenna configured to generate a signal in response to exposure to electromagnetic radiation, signal processing circuitry configured to process the signal generated by the at least one antenna, a microprocessor configured to determine, from the processed signal, whether the alert device is proximate to the active AC voltage source, a communication device configured to generate a signal in response to a determination that the alert device is proximate the active AC voltage source, and an interference reduction device configured to discharge an accumulated charge on the alert device to reduce electromagnetic interference from sources other than the active AC voltage source.

### CROSS REFERENCE TO RELATED APPLICATIONS

This application is a continuation-in-part of U.S. patent application Ser. No. 15/913,434, filed on 6 Mar. 2018, and is a continuation-in-part of U.S. patent application Ser. No. 16/136,423, filed on 20 Sep. 2018.

U.S. patent application Ser. No. 16/136,423 is a divisional of U.S. patent application Ser. No. 14/541,370, filed on 14 Nov. 2014.

U.S. patent application Ser. No. 14/541,370 claims priority to U.S. Provisional Patent Application Nos. 61/940,813; 61/940,660; 61/940,610; and 61/940,696, all of which were filed on 17 Feb. 2014, and is a continuation-in-part of U.S. patent application Ser. No. 14/217,672, filed on 18 Mar. 2014, is a continuation-in-part of U.S. patent application Ser. No. 14/253,294, which was filed on 15 Apr. 2014 (now U.S. Pat. No. 9,875,414), is a continuation-in-part of U.S. patent application Ser. No. 14/457,353, filed 12-Aug.-2014, is a continuation-in-part of U.S. patent application Ser. No. 14/479,847, filed on 8 Sep. 2014, is a continuation-in-part of U.S. patent application Ser. No. 14/485,398 (now U.S. Pat. No. 10,049,298), and is a continuation-in-part of U.S. patent application Ser. No. 13/109,209, filed on 17 May 2011 (now U.S. Pat. No. 8,913,131).

U.S. patent application Ser. No. 13/109,209 is a divisional application of U.S. patent application Ser. No. 11/146,831, filed on 6 Jun. 2005 (now U.S. Pat. No. 7,965,312), which claims priority to U.S. Provisional Application No. 60/626,573, filed on 10 Nov. 2004, and is a continuation-in-part of U.S. patent application Ser. No. 10/361,968, filed on 10-Feb.-2003.

U.S. patent application Ser. No. 10/361,968 claims priority to U.S. Provisional Application No. 60/385,645, filed on 4 Jun. 2002.

U.S. patent application Ser. No. 14/479,847 is a continuation-in-part of U.S. patent application Ser. No. 14/217,672.

U.S. patent application Ser. No. 14/457,353 and U.S. patent application Ser. No. 14/485,398 each claim priority to U.S. Provisional Application Nos. 61/940,813; 61/940,660; 61/940,610; and 61/940,696 filed on 17 Feb. 2014.

All of the foregoing are incorporated herein by reference in their entirety, including the drawings, for all purposes.

### BACKGROUND

### Technical Field

The subject matter described herein relates to detection devices and methods.

### Discussion of Art

At least some known detection devices are wearable devices. Design constraints for wearable devices appear to seek a physically thin, unobtrusive and low profile. Some detection devices may be used to sense voltage or the presence of noxious material.

Existing voltage sensing devices are used to detect active voltage sources within a determined distance of the device. At least some known voltage sensing devices must be intentionally activated by a user (i.e., they are not passive, automatic sensing devices). In addition to manual activation, they have a relatively limited range. When an active voltage source is detected an alarm sounds, and this alarm emits at least some electromagnetic interference. The electromagnetic interference may affect the sensor input element, and this may impact the ability of the voltage sensing device to accurately detect active voltage sources. Further, at least some known voltage sensing devices include a housing made of an electrically insulative material, such as silicone rubber. When the housing contacts another object, an electric charge may accumulate on the housing. This accumulated electric charge may interfere with the voltage sensing device.

Many sensing input elements for detecting noxious elements are bulky, use wet chemistry, or require sophisticated equipment (such as gas chromatography and atomic absorption spectroscopy). These devices detect chemicals in liquid or gas form that a person may not want to contact, inhale or ingest. These substances may be organic or metallic, and/or may be radioactive (e.g., Radon gas). The detectors may be hand held, such as a Geiger counter, or may be a wearable coupon (such as a color changing strip). Dosimeters may collect data about discrete exposures to radiation levels. Sensing input elements may have false positives based on environmental interference. For example, gas analyzers may not be able to distinguish analytes of interest from nuisance gas species, and radiation detectors may mistake one form of radiation for another.

It may be desirable to have a detection device and method that differs from those that are currently available.

### BRIEF DESCRIPTION

In one aspect, a detection device for detecting proximity to an active alternating current (AC) voltage source is provided. The device includes a housing sized and shaped to be worn by a user, at least one antenna embedded in the housing, the at least one antenna configured to generate a signal in response to exposure to electromagnetic radiation, signal processing circuitry embedded in the housing and communicatively coupled to the at least one antenna, the signal processing circuitry configured to process the signal generated by the at least one antenna, a microprocessor embedded in the housing and communicatively coupled to the signal processing circuitry, the microprocessor configured to determine, from the processed signal, whether the voltage detection device is proximate to the active AC voltage source, an alert device embedded in the housing and communicatively coupled to the microprocessor, the alert device configured to generate an alert in response to a determination that the voltage detection device is proximate the active AC voltage source, and an interference reduction device embedded in the housing and communicatively coupled to the microprocessor, the interference reduction device configured to discharge an accumulated charge on the voltage detection device to reduce electromagnetic interference from sources other than the active AC voltage source.

In one aspect, a detection system is provided that includes a housing, a sensing first circuit, a communication device, and an interference second circuit. The housing may be worn by a user or carried on a mobile device. At least one sensing first circuit is selectively coupled to the housing and can sense or detect one or more of electromagnetic radiation, ionizing radiation, a determined liquid analyte, a determined gaseous analyte, a determined powdered analyte concentration, a level of oxygen below a determine threshold value, a data signal strength, a determined level of magnetic flux, a temperature, and a pressure. The at least one communication device can generate and/or communicate a signal in response to the sensing or detecting by the sensing circuit. The interference second circuit can reduce or eliminate interference by the sensing first circuit.

In another aspect, a method for detecting proximity of a voltage detection device to an active alternating current (AC) voltage source is provided. The voltage detection device includes a housing sized and shaped to be worn by a user. The method includes generating, using at least one antenna embedded in the housing, a signal in response to exposure to electromagnetic radiation, processing the generated signal using signal processing circuitry embedded in the housing and communicatively coupled to the at least one antenna, determining, using a microprocessor embedded in the housing and communicatively coupled to the signal processing circuitry, based on the processed signal, whether the voltage detection device is proximate to the active AC voltage source, generating, using an alert device embedded in the housing and communicatively coupled to the microprocessor, an alert in response to a determination that the voltage detection device is proximate the active AC voltage source, and discharging, using an interference reduction device embedded in the housing and communicatively coupled to the microprocessor, an accumulated charge on the voltage detection device to reduce electromagnetic interference from sources other than the active AC voltage source.

In one aspect, a method includes collecting one or more hazardous or sub-hazardous readings. The hazardous or sub-hazardous readings are compared to an associated set of determined threshold values. If the one or more hazardous or sub-hazardous readings exceed at least one of the determined threshold values, the method responds by dispatching maintenance and service workers to a location where the one or more hazardous or sub-hazardous readings were generated to identify and address a cause of the one or more hazardous or sub-hazardous readings; generating a heat map of the one or more hazardous or sub-hazardous readings; and monitoring locations and/or vectors of a plurality of users. If any one of such plurality of users moves within a determined distance of the area of the heat map, the method continues by one or more of: dispatching emergency medical and/or hazardous material teams to a location of such users; and alerting such users that a possibility of a hazardous condition exists; and monitoring such user's vital signs for a change that could indicate distress of such individual; and changing an operation associated with the cause of the one or more hazardous or sub-hazardous readings. Changing the operation may include one or more of switching a lock condition of a door that leads to or from a location corresponding to the area of the heat map; and initiating a ventilation system to seal the location; and initiating a ventilation system to ventilate the location; and de-energizing a circuit in the location; and initiating a fire suppression system at the location.

### DRAWINGS

These and other features and aspects of the disclosure may be read with the detailed description, and like characters represent like parts throughout the drawings, wherein:

FIG. 1 is a block diagram of an example voltage detection device;

FIG. 2 is a schematic diagram of an example wristband that may constitute the voltage detection device shown in FIG. 1;

FIG. 3 is a schematic diagram of an example glove that may constitute the voltage detection device shown in FIG. 1;

FIG. 4 is a schematic diagram of one embodiment of an antenna, signal processing circuitry, microprocessor, and alert device that may be used with the voltage detection device shown in FIG. 1;

FIG. 5 is a schematic diagram of an alternative embodiment of an antenna, signal processing circuitry, microprocessor, and alert device that may be used with the voltage detection device shown in FIG. 1;

FIG. 6 is a schematic diagram of an alternative embodiment of an antenna, signal processing circuitry, microprocessor, and alert device that may be used with the voltage detection device shown in FIG. 1;

FIG. 7 is a schematic diagram of an alternative embodiment of an antenna, signal processing circuitry, microprocessor, and alert device that may be used with the voltage detection device shown in FIG. 1; and

FIG. 8 is a block diagram illustrating operation of a motion or contact sensor that may be used with the voltage detection device shown in FIG. 1.

### DETAILED DESCRIPTION

The subject matter described herein relates to detection devices and methods. In one embodiment, a wearable voltage detection device detects proximity to active voltage sources and alerts accordingly.

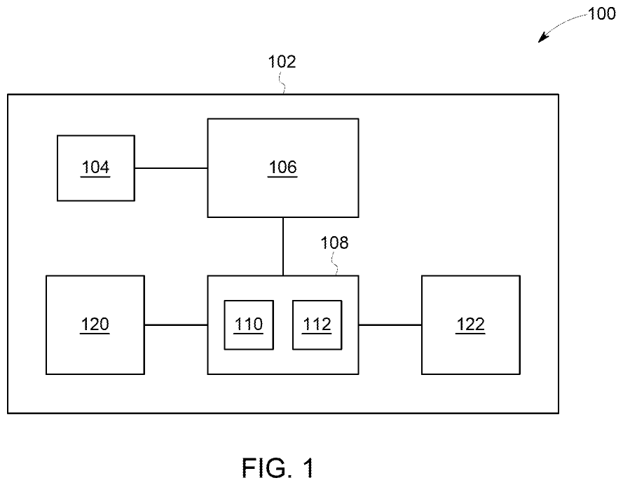

With reference to FIG. 1, a block diagram of an alert device 100 that includes features and aspects of the inventive subject matter is shown. The voltage detection device may include a housing 102 containing a plurality of components, as described in detail below. At least one antenna 104 may be coupled to the housing. The antenna may be communicatively coupled to signal processing circuitry 106 that may be also couple to the housing. The alert device may be communicatively coupled to a microprocessor or controller 108 that includes a memory device 110 and one or more processors 112 coupled to the memory device. The alert device may include one or more user and/or hazard sensors 120 embedded in the housing. The controller may be communicatively coupled to the signal processing circuitry. In some embodiments, the alert device may include an interference reduction device 122.

The illustrated alert device may be wearable by a user and may facilitate detecting a hazardous condition located near the user or current state of the user. A user sensor may monitor and/or detect a condition of the user that is wearing such an alert device. A hazard sensor package may detect the hazardous condition. The alert device may respond to such detection by logging the event, noting the location, warning the user, and/or communicating hazard information to a backend system that may perform further actions based thereon.

An example of a hazardous condition may be that an active voltage source (e.g., a current carrying wire) is nearby. A suitable alert device may detect voltages in a range greater than about 50 volts. In one embodiment, the voltage detector may detect voltages in a range of from about 50 to about 1000 VAC. In other embodiments, the alert device may be capable of detecting another range of voltages that enables the alert device to function as described herein. The voltage detection may be direct current (DC), alternating current (AC), or both.

Although the alert device may be described herein as detecting the presence of an active AC voltage source, the alert device may include other or additional hazard sensors for detecting other phenomena. For example, the alert device may include temperature detection or chemical detection sensors. Other suitable sensors may include one or more magnetometers, force sensors, movement sensors (e.g., accelerometers, global positioning system sensors, etc.), temperature sensors, chemical and/or gas sensors, optical sensors (e.g., camera and/or fiber optic), impedance and/or resistance sensors, acoustic sensors (i.e., microphone), locations sensors (e.g., global positioning system sensor/GPS and/or relative location, such as proximity to a beacon) and may be selected based on application specific criteria.

Returning to an example alert device that may detect voltage sources, in one embodiment that detection may be within a determined distance range of the alert device and/or also within an angular range of the alert device. In the example embodiment, the distance range of the alert device is about 1 meter (i.e., the alert device may detect voltage sources up to 1 meter from the alert device). Further, in the example embodiment, the alert device has a substantially omnidirectional angular range. That is, the alert device may detect voltage sources in substantially any direction relative to the alert device. Alternatively, the alert device may have a distance range and angular range that enables the alert device to function as described hereinbelow such that the angular range may be limited to a narrow band, and if coupled to another like sensor at a perpendicular orientation it may be possible for the device to not only detect the hazardous condition but also to indicate a general direction relative to the device.

In one embodiment, the alert device may be a passive device that does not require the user to intentionally activate the alert device or provide input to the alert device to initiate detection. Instead, the alert device automatically monitors for and detects voltage sources and alerts the user to those detections. Alternatively, the alert device may be an active device that requires user input to initiate detection. Optionally, the alert device may be activated (e.g., turn on) or deactivated (e.g., turn off) based on movement and/or orientation of the alert device. For example, signals generated by the accelerometer of the alert device can indicate whether the alert device is resting on a surface or is being worn by a user (e.g., which would indicate movement of the alert device). The alert device (or some components thereof) can be turned on or activated based on the signals indicating movement and deactivated based on the signals indicating no movement. This can result in the alert device (or some components thereof) being turned on once the user begins wearing the alert device and turned off once the user stops wearing the alert device.

In one example, the alert device (or some components thereof) can be activated or deactivated) based on whether a user is wearing the alert device and based on the location of the alert device. One or more geofences can be used to establish areas where the alert device is activated, regardless of whether the alert device is being worn by a user. For example, the alert device may always be activated while the alert device is in an area associated with a mine, an area associated with a high voltage environment, an area associated with one or more chemical analytes, etc., even if signals generated by an accelerometer indicate that the alert device is not being worn. This can prevent the alert device from being deactivated while in a potentially hazardous location.

The alert device may be automatically activated or deactivated depending on the presence of one or more redundant sensors within the proximity of the alert device. For example, the alert device may be configured to detect whether an AC source is nearby. The locations of one or more other AC sensors may be associated with different (overlapping or non-overlapping) geofences. The alert device (or at least the sensor of the alert device that senses AC) may be deactivated while the alert device is within one or more of these geofences and activated while the alert device is outside the geofences. That can prevent the alert device from consuming energy to sense AC while one or more external, redundant AC sensors already are present to sense AC near the alert device.

To reduce or eliminate charge build-up on the alert device having a voltage sensor, the housing may be fabricated from an electrically dissipative material. A suitable electrically dissipative material may have a polymeric base and a conductive filler. In another embodiment, the electrically dissipative material may be inherently conductive without the use of a filler. Suitable intrinsically conductive polymers may include one or more of polyanilines, polypyrrols and polythiophenes. For filled electrically conductive materials, a suitable polymeric base may be polyurethane, nylon, rubber, or another plastic selected based on application specific criteria. Suitable filler material may include carbon, metal and the like. A suitable electrically dissipative material may have a resistivity in a range of less than about 1×10⁸ ohm centimeters (Ω·cm), or in a range of from approximately 1×10⁸ ohm centimeters (Ω·cm) to about 1×10¹⁰ Ω·cm, or in a range of greater than about 1×10¹⁰ Ω·cm. A lower resistivity (e.g., 1×10⁶ Ω·cm) may reduce detection sensitivity of the alert device. The type of electrically dissipative material may be determined at least in part by the parameters of the end use application.

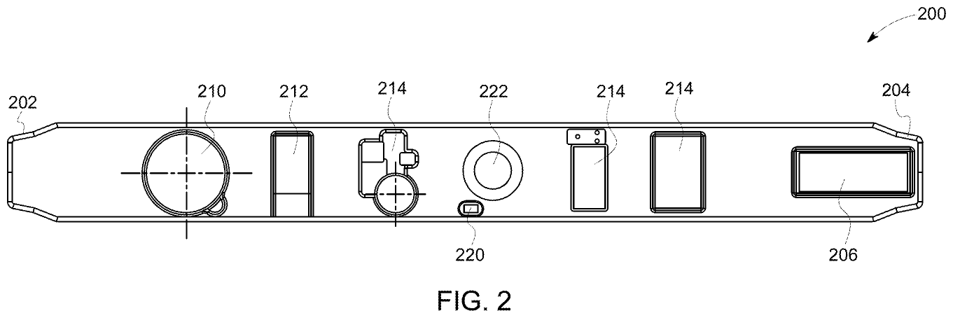

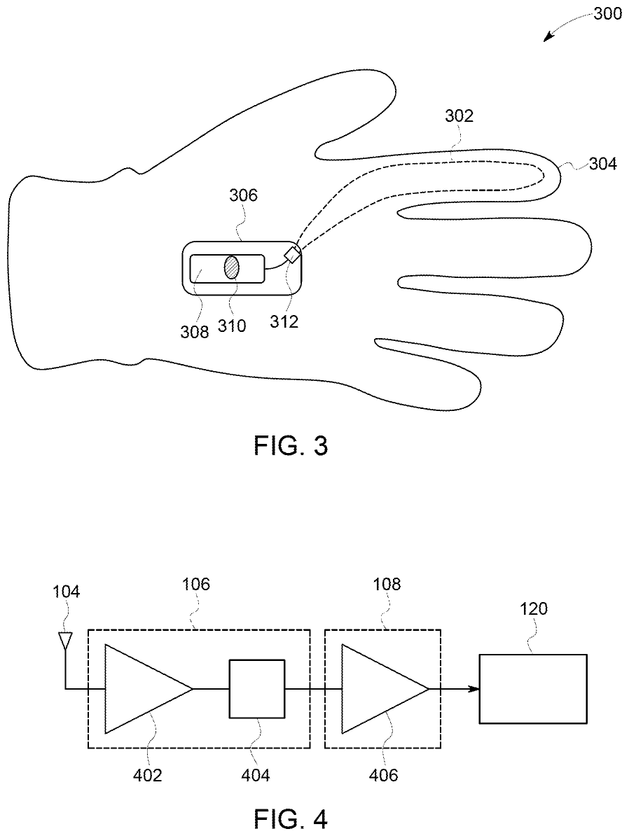

The housing may be sized and shaped to be worn by a user. For example, the housing may form a wristband (as shown in FIG. 2) or a glove (as shown in FIG. 3). Other suitable configurations for the housing may include a modular design (not shown) that is attachable to a variety of gear having a fastener that accepts the form and fit of the housing. In some applications, the fastener may simply be a Velcro-like system. In other applications, the housing may be securable with a lanyard, a clip, or in a pocket. In one embodiment, the housing may be water-resistant and/or submersible. Other wearable options are included within the scope of the subject matter described herein, including shirts, pants, hats (e.g., hardhats), glasses or goggles, shoes, watches, etc.

During operation, the antenna may generate a signal in response to exposure to electromagnetic radiation (e.g., generated by a voltage source). A suitable antenna may be, for example, a loop of wire. In other embodiments, the antenna may have a configuration that enables the alert device to function as described herein. Another suitable antenna may be printed on an inherently static dissipative material, such as thermoplastic polyurethane (TPU). Alternatively, the antenna may have a segmented antenna structure with individual sense channels. That is, multiple antennae may be used.

The signal processing circuitry may receive and process the signal generated by the antenna. For example, the signal processing circuitry may perform filtering and/or amplification on the signal generated by the antenna. Different voltage sources may have different signatures. In one embodiment that can detect an AC voltage source, the signal generated by the antenna in response to its exposure to the active AC voltage source may have a frequency in a range from about 50 Hertz (Hz) to about 60 Hz. the signal processing circuitry may filter out signal components outside of a similar range (that is, from approximately 50 Hz to 60 Hz) such that signal components that may not indicate an active AC voltage source are removed. The signal processing circuitry may identify and filter out known noise signatures (e.g., fluorescent lights, welding equipment, motor starters, and the like).

The controller determines, from the processed signal generated by the signal processing circuitry, whether the alert device may be proximate to an active AC voltage source. The controller may make this determination continuously or periodically (i.e., at a determined sampling rate). Further, the sampling rate may be dynamically adjusted (e.g., to reduce power consumption, improve detection, and the like) during operation.

The processors may include one or more processing units, such as a multi-core configuration. Executable instructions may be stored in the memory device. The controller may perform one or more operations described herein by programming the processor. For example, the processor may be programmed by encoding an operation as one or more executable instructions and providing the executable instructions in the memory device. In the example embodiment, the memory device may be one or more devices that enable storage and retrieval of information such as executable instructions or other data. The memory device may include one or more computer readable media, such as, without limitation, random access memory (RAM), dynamic RAM, static RAM, a solid-state disk, a hard disk, read-only memory (ROM), erasable programmable ROM, electrically erasable programmable ROM, or non-volatile RAM memory. In one embodiment, the controller may include a wireless communications interface for transmitting data from the alert device to a remote computing device for storage and/or analysis. The remote device may be proximate (such as a communication with a smart phone, tablet or other personal computing device) or may be distant (such as a backend computer system in a cloud server arrangement). The location of the controller may be selected based on application specific parameters, to include power consumption, environmental interference, distance to receivers, and the like.

If the controller determines that the alert device may be proximate to, that is, within a determined distance of, an active voltage source, the controller causes the alert device to generate an alert or signal. Depending on the use case and application, the generated signal may be one or more of an audio, visual, and/or haptic/tactile signal that makes a user aware that the alert device may be near to an active voltage source. For example, the signal may include a blinking light, a color-changing light, an audible signal (e.g., a beeping sound or siren sound), or a vibration.

In one embodiment, the alert device may include a housing, an antenna, signal processing circuitry, and microprocessor to facilitate detecting active voltage sources. The alert device may include a shunt, a grounding circuit, or an interference reduction device (collectively referred to as an interference reduction device) to reduce or eliminate electromagnetic interference (EMI) from sources other than active AC voltage sources. In addition, the alert device may leverage particular materials and processing components to reduce or eliminate interference signals, improving the ability of the alert device to detect active AC voltage sources.

During use, electrical charge may accumulate on the alert device. The interference reduction device can discharge accumulated charge on the alert device. This accumulated electrical charge may cause electromagnetic interference that impedes the ability of the alert device to accurately detect the presence of an active AC voltage source. For example, accumulated electrical charge may cause the alert device to generate a false alarm when no active AV voltage source may be present.

In one embodiment, the interference reduction device may be operable to reduce electromagnetic interference generated by other, external sources of electromagnetic radiation. The interference reduction device may discharge any accumulated charge after a determined period of time (e.g., after a determined number of cycles of a signal generated by the communication device) and/or after certain conditions may be satisfied (e.g., after an accumulated charge on the alert device reaches a threshold value level). Accordingly, after the interference reduction device discharges any accumulated charge, the alert device can again attempt to detect (without interference from the accumulated charge) the presence of an active AC voltage source.

With reference to FIG. 2, an example wristband 200 is shown that acts as a housing that supports an alert device. The wristband may be flexible and may be sized and shaped to be worn on a wrist of a user. The wristband extends between a first end 202 and an opposite second end 204. Further, the wristband may include a coupling mechanism 206 for coupling the first end to the second end (i.e., such that the wristband forms a loop that encircles the user's wrist). The coupling mechanism may be a hook and loop fastener. In other embodiments, the coupler may be a magnetic fastener, a snap-fit fastener, or other suitable coupling device.

The wristband may include an energy source 210. In one embodiment, the energy source is a rechargeable battery that may be recharged via a charging port 212 (e.g., a micro USB charging port). Other suitable energy sources may include a motion driven generator, a solar cell, a hydrogen cell, and the like. The wristband may include a plurality of electronics components 214 that may include, for example, an antenna, signal processing circuitry, controller, communication device, location/locator device, and/or an interference reduction device (as shown in FIG. 1). In one embodiment, the antenna may be a conductive loop that extends between first and second ends.

A suitable communication device may be a light-emitting diode (LED) 220, as shown in FIG. 2. LED may function as a communication device (e.g., by generating visual signals) and/or may be used to indicate, for example, a charge status or power level of wristband. In the example embodiment, the wristband may support a user input device 222 (e.g., a switch or buttons) that enables selectively activating one or more components of wristband. Using the user input device, the user may adjust sensitivity (e.g., adjust the detection range) of the wristband. Optionally, the sensitivity may be adjusted based on the location of the wristband or sensor. For example, the farther that the wristband or sensor is from a designated location (e.g., the office, outside of a mine, outside of a building, etc.), the lower the sensitivity of the wristband or sensor. This can avoid or reduce nuisance alarms or false detections when the user is outside of an area where a hazard may exist or is within an area where the hazard is known to not exist (or has a much lower likelihood of existing). The sensitivity of the wristband or sensor can increase responsive to the user entering an area where the hazard is more likely to exist. For example, the sensor or watchband can be more sensitive to a hazard responsive to the sensor or watchband moving closer to a powered device (e.g., a device receiving AC and/or DC).

A user sensor package 224 may include one or more of a heart rate monitor, a blood oxygen content sensor, a blood alcohol sensor, a blood sugar sensor, a blood pressure sensor, a skin temperature sensor, a perspiration sensor, or another sensor based on application specific parameters. Suitable sensors for a device may be selected based on application specific parameters, including parameters specific to the user and/or the environment. If a user is known to have a health condition, such as diabetes, then the sensors may include a blood sugar monitor. If the user environment involves closed spaces, then a blood oxygen sensor may be included.

An environmental sensor package 226 may include one or more hazard sensors. Suitable hazard sensors may include one or more of an active AC voltage sensors, temperature detection or chemical detection sensors, magnetometers, force sensors, temperature sensors, chemical and/or gas sensors, optical sensors (e.g., camera and/or fiber optic), impedance and/or resistance sensors, acoustic sensors (i.e., microphone), locations sensors (e.g., global positioning sensor/GPS and/or relative location, such as proximity to a beacon) and these may be selected based on application specific criteria.

During use, the user sensor package may monitor a health condition of the user and do one or more of store such information, transmit such information, or analyze such information. If analysis is done on the device, designated threshold values may be compared to sensed parameters. If such sensed parameter values cross the designated threshold value, the device may respond by alerting the user, signaling a backend data system, or interacting with a related nearby system. For example, if the skin temperature sensor shows overheating of the user an overheating indicium may be provided to the user. This may prompt the user to reduce strenuous activity, move to a cooler environment, increase water intake, or the like. Prolonged exposure to the elevated temperature may cause the device to respond with additional and increasingly urgent indicia. On device analysis may occur by accumulating data over time. For example, radiation exposure may be cumulative. As such, the device may not only sense the amount and duration of radiation exposure but may accumulate and aggregate such exposure events and alert upon reaching a designated total accumulated radiation exposure level.

In one embodiment, the communication device communicates sensed data from the device to the backend system. The sensing first circuit may detect one or more hazardous or sub-hazardous readings, and the communication device may transmit those readings, and additional information, to the backend system. That is, location information from the locating device is provided with the sensed data. Time/date information is provided with the sensed data and the location information. The backend system analyzes the hazard information and other signals generated by the wristband device. Based at least in part on the analysis the backend system may warn other users (based on their locations) that they may be in or may be approaching an area where a hazard was indicated by the combination of the signal and the location. The warning may be general in nature or may indicated the type and severity of the hazard.

The reference to sub-hazardous refers to a reading that is atypical, but not necessarily hazardous to the user. For example, a camera or photovoltaic array may notice that ambient lighting is below a designated level, and enough readings have signaled the same in the same location that a false positive has been ruled as unlikely. In response, maintenance may be dispatched to see if a there are malfunctioning light bulbs that need attending.

Based at least in part on the analysis, the backend system may dispatch maintenance to an area when the signal indicates that a threshold value of one or more sensible attributes has been achieved or surpassed. As part of the analysis, the backend system may generate a heat map of the one or more hazardous or sub-hazardous readings, and based on determined threshold values associated with an area of the heat map to initiate one or more of dispatch maintenance and service workers to identify and address a cause of the one or more hazardous or sub-hazardous readings; and monitor locations and/or vectors of a plurality of detection systems, and to identify users of such detection systems as such users move within a determined distance of the area of the heat map. The vectors can indicate the direction (e.g., heading) and/or speed that the users are moving. In response, the system may cause a change an operation associated with the cause of the one or more hazardous or sub-hazardous readings; and alert such users that a possibility of a hazardous condition exists; and monitor such user's vital signs for a change that could indicate distress of such individual; and dispatch emergency medical and/or hazardous material teams to a location of such users.

The personnel that is dispatched to an area may be tailored to the location and/or equipped based at least in part on the hazardous or sub-hazardous readings that were detected. For example, if the reading indicates a fire (e.g., elevated temperatures), then the personnel that is dispatched may have fire suppression systems (e.g., fire extinguishers). If the reading indicates a particular analyte, then the personnel that is dispatched may be wearing gear that protects the personnel from the analyte. If the reading indicates a low oxygen content in an area, then the personnel that is dispatched may be equipped with oxygen tanks.

A suitable change in operation may include, for example, switching a lock condition of a door that leads to or from a location corresponding to the area of the heat map; initiating a ventilation system to seal or ventilate the location; and de-energizing a circuit in the location. For example, if a user device has a voltage sensor that detects a proximate high-voltage source, the communication device may signal to all high voltage machines proximate to the user's location to de-energize. As another example, if elevated temperatures indicative of a fire are detected, then the change in operation can be activation of a fire suppression system (e.g., fire extinguishers, fire sprinklers, etc.). If the user is anticipating working close to live high voltage sources, the user device can be set to de-energize (e.g., turn off) the high voltage source if the user's heart rate moves to an abnormal state while the location indicates proximity to a high voltage source. A distress alert may be triggered to summon medical assistance, while providing the location of the potentially injured user. In one embodiment, the sensing first circuit can detect one or more hazardous readings, and the communication device is configured to transmit those readings, and additional information, to the backend system. The additional information includes at least the location of the one or more hazardous readings and vital signs of a user of the detection system, wherein a change in the vital signs that could indicate distress of such individual initiates a request for aid for such user to be dispatch to the user location.

FIG. 3 may be a schematic diagram of a glove 300 that supports or includes the alert device. The glove may be sized and shaped to be worn on a hand of a user. Alternatively, it may be of a large size and may be adjustable to fit different hand sizes. A loop antenna 302, may be embedded in the glove. In one embodiment, it may extend through at least one finger 304 of glove.

The glove may include a pouch or pocket 306 that may be sized to receive an energized electrical communication device (EEAD) 308. The EEAD may include signal processing circuitry, a controller, a communication device, and/or an interference reduction device. A suitable communication device may be an LED 310 (e.g., by generating visual signals). If desired, the communication device may be multi-functional, such as, for example, it may be used also to indicate a charge status of a battery, or a power level of the EEAD, or a strength of the detected parameter, or a health check for the device's capabilities. The pocket may include a connector 312 that communicatively couples the loop antenna to the EEAD while it is inserted into the pocket. Because the EEAD may be removable from the pocket, the EEAD can be removed and inserted into another glove or item of equipment. The EEAD may be used with different types of gloves selected for use in different applications.

FIG. 4 is a diagram that shows a system with an antenna, signal processing circuitry, a controller, and a communication device so as to be similar to the device shown in FIG. 1. In the illustrated embodiment, the signal processing circuitry may include an amplifier 402 and a filter 404. The amplifier amplifies the signal received from the antenna to increase sensitivity (e.g., to detect relatively low voltage signals). Further, the filter filters the amplified signal. The filter may filter out signal components outside of a determined frequency range.

The controller may include a threshold value detector 406. The threshold value detector compares the processed signal to a determined threshold value (e.g., a threshold voltage value), and thereby to detects the presence of an active voltage source when the processed signal exceeds the determined threshold value. A determined threshold value may be defined and stored, for example, in the memory device. Upon detecting an active voltage source greater than the threshold value, the controller may instruct the communication device to generate a signal.

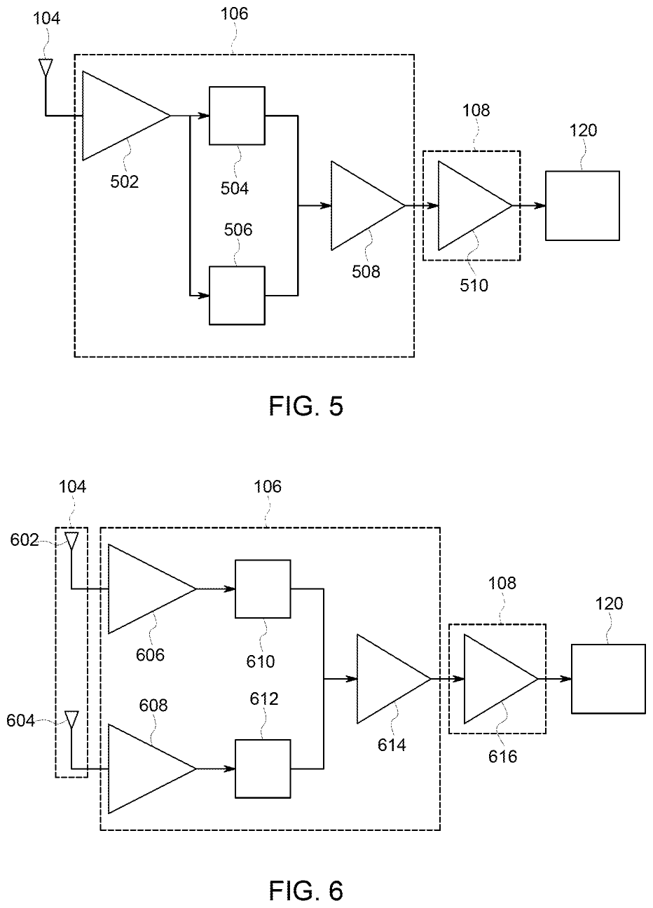

FIG. 5 is a schematic diagram of an embodiment having an antenna, signal processing circuitry, a controller, and a communication device so as to be similar to the device shown in FIGS. 1 and 4. The signal processing circuitry may include an amplifier 502 that amplifies the signal received from the antenna to increase sensitivity (e.g., to detect relatively low voltage signals). The signal processing circuitry may include a first filter 504 and a second filter 506 coupled in parallel to an output of the amplifier. First and second filters filter the amplified signal. For example, the first filter may be a 60 Hz notch filter, and the second filter may be a broadband filter. To minimize false alarms, the outputs of first and second filters may be combined by a signal combiner 508. A threshold value detector 510 of the controller compares the output of signal combiner signal to a determined threshold value (e.g., a threshold voltage value), and detects the presence of an active AC voltage source when the processed signal exceeds the determined threshold value. The determined threshold value may be defined and stored, for example, in the memory device. Upon detecting an active voltage source, the controller instructs the communication device to generate a signal. The signal may be binary, on/off, or may be graduated such that a stronger input (nearer a voltage source) may generate a proportionally stronger output signal.

In the embodiment shown in FIG. 6, the antenna may include a first antenna 602 and a second antenna 604. Using multiple antennas facilitates localizing a detected electric field. This may be done to minimize spurious detections from other power sources that the active AC voltage sources. For example, in this embodiment, the first antenna has a first orientation, and the second antenna has a second orientation substantially orthogonal to the first orientation. Other orientations, such as skew, may be used in suitable applications.

As shown in FIG. 6, signal processing circuitry may include a first antenna 602 and a second antenna 604. A first amplifier 606 communicatively couples to first antenna and a second amplifier 608 communicatively couples to second antenna. Each of first and second amplifiers may amplify the signal received from the respective antenna to increase sensitivity (e.g., to detect relatively low voltage signals). A first filter 610 and a second filter 612 may be communicatively coupled to first and second amplifiers, respectively.

The outputs of first and second filters may be combined by a signal combiner 614. A threshold value detector 616 of the controller compares the output of the signal combiner signal to a determined threshold value (e.g., a threshold voltage value), and detects the presence of an active AC voltage source when the processed signal exceeds the determined threshold value. The determined threshold value may be defined and stored, for example, in the memory device. Upon detecting an active voltage source, the controller may instruct the communication device to generate a signal.

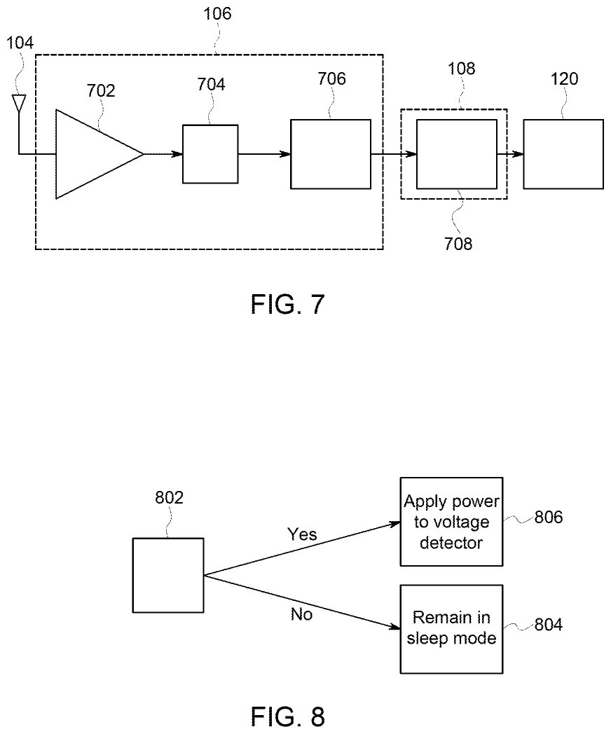

In the embodiment shown in FIG. 7, the signal processing circuitry may include an amplifier 702. The amplifier amplifies the signal received from the antenna to increase sensitivity (e.g., to detect relatively low voltage signals). The signal processing circuitry further may include a filter 704 that filters the amplified signal. An analog to digital converter (ADC) 706 digitizes the output of the filter. Accordingly, the controller may include digital circuitry 708 (e.g., digital filters, discriminator, threshold value detector, waveform display) to determine the presence of an active voltage source and instructs the communication device to generate and/or communicate a signal as appropriate. In one embodiment, the filter circuit may be omitted, and filtering may be performed by digital manipulation of the digital circuitry. Digital signal processing allows for the use of various processing algorithms. In one embodiment, the signal is processed by different signal bands, dynamic threshold values are generated, and/or sensitivity to rate of change in a detected electromagnetic field may be controlled.

With reference to FIG. 8, the alert device may include at least one motion or contact sensor that automatically detects that a user may be wearing the alert device, and activates alert device (e.g., by activating the controller) accordingly. The alert device may include a voltage generator capable of generating a small voltage calibration signal to test operation/adjust sensitivity of the alert device. In another embodiment, the alert device may include an energy source. Suitable energy sources may include an energy harvester (e.g., a piezoelectric device) that charges a battery of the alert device from motion and/or exposure to electric fields.

The alert device may include at least one motion or contact sensor that automatically detects that a user may be wearing the alert device, and activates alert device (e.g., by activating the controller) accordingly. A use or wear sensor 802 may determine that a user is (or is not) wearing the alert device or that the device is in use.

In the illustrated embodiment, the wear sensor may be an accelerometer that detects movement of the alert device (which may be indicative of a user wearing the alert device). In another embodiment, the wear sensor may be a contact or touch sensor that detects contact with the skin of a user (which may be indicative of a user wearing the alert device). Other suitable wear sensors may include one or more force sensors, temperature sensors, chemical and/or gas sensors, optical sensors (e.g., camera and/or fiber optic), impedance and/or resistance sensors, acoustic sensors (i.e., microphone), and may be selected based on application specific criteria. As examples, a force sensor may be pressed or activated when the device is being worn. An impedance sensor may detect contact with skin. An acoustic sensor may be voice-activated or may detect the sound of breathing or a heartbeat. A fiber optic may be a fiber that is stressed (optically detectable stressing) in response to being wrapped around a wrist, or by pressure placed on the sole of a shoe, for example. In one example, the wear sensor may function as a health monitor of the user. An accelerometer may detect sharp or sudden impact and may sense orientation (i.e., if the user is upright or prone).

A suitable portable camera unit may be an Internet protocol camera unit, such as a camera that can send video data wirelessly to a network or to a data storage device. In one aspect, the camera can be a digital camera capable of obtaining relatively high-quality image data (e.g., static or still images and/or videos). For example, the camera may be an Internet protocol (IP) camera that generates packetized image data. The camera can be a high definition (HD) camera capable of obtaining image data at relatively high resolutions. For example, the camera may obtain image data having at least 480 horizontal scan lines, at least 576 horizontal scan lines, at least 720 horizontal scan lines, at least 1080 horizontal scan lines, or an even greater resolution. Alternatively, the camera may be another type of camera.

The data storage device may be communicatively coupled to, e.g., electrically connected, the camera unit to store the image data. The data storage device may include one or more computer hard disk drives, removable drives, magnetic drives, read only memories, random access memories, flash drives or other solid-state storage devices, or the like. Optionally, the data storage device may be disposed remote from the camera unit, such as by being separated from the camera unit by at least several centimeters, meters, kilometers, as determined at least in part by the application at hand.

The use of the wear sensor may increase battery life and minimizing power consumption of the alert device. In the example embodiment, the wear sensor continuously or periodically determines whether motion or contact may be detected. If wear sensor does not detect motion or contact, one or more components of the alert device (e.g., the signal processing circuitry, the controller, and/or the communication device) remain 804 in a sleep mode, or low-power consumption mode. When the wear sensor does detect motion or contact, the one or more components may be activated (i.e., by applying power 806 to those components) such that the alert device can readily detect active AC voltage sources. Further, if wear sensor does not detect motion or contact for a determined period of time after activating the one or more components, the alert device returns to the low-power mode.

The embodiments described herein include a wearable alert device that detects proximity to active AC voltage sources and signals a wearer accordingly. The alert device may include a housing, and an antenna, signal processing circuitry, and microprocessor to facilitate detecting active AC voltage sources. The alert device further may include an interference reduction device to reduce electromagnetic interference from sources other than active AC voltage sources. In addition, the alert device leverages particular materials and processing components to reduce or eliminate interference signals, improving the ability of the alert device to detect active AC voltage sources.

In one use case, a wearable alert device can be worn in a mining environment. Suitable mining environments may include above ground mining and below ground mining. These environments may differ insofar as below ground mining may have substantial amounts of material (dirt, rock, ore) between transmitters on the wearable alert device and the receivers. Above ground mines may have open air, but may have more distance between transmitter and receiver, material in some instances, weather conditions, and electromagnetic interference. Hot dry conditions may exacerbate static electricity build up on the wearable device. The dynamic nature of the above ground environment differs from the relatively static and unchanging environment below ground. The inventive wearable device may be tailored and optimized for its intended use environment.

In another use case, a wearable device may be used in a marine environment. As such, it may be water-proofed to a greater degree than a land-based wearable device according to embodiments of the invention. The difference between a salt water and fresh water application may also affect configuration and operation of the wearable device. The location function then may be based on a receiver mounted to the vessel. A loss of signal from the wearable device may indicate a hazardous condition, such as damage to the wearable device (and by implication to the user) or the user being lost from the vessel and moving out of range.

In yet another use case, a wearable device may be used in a transportation environment (such as rail or trucking) in which freight and/or people may be transported from one location to another. In this case, the wearable device may be configured to accept jumps in location from a first area and network to another area and network. A wearable device, being monitored, that disappears from a closed location may be treated in a different way than another wearable device that is expected to enter and leave a defined location. That is, it might trigger an alert in the case where the user isn't expected to leave; but it may signal a notice that a user has left the vicinity in the case where users are expected to travel (as in a locomotive operator entering or leaving a rail yard.

An example technical effect of the methods, systems, and apparatus described herein may include at least one of: (a) using non-contact voltage sensing to determine if a user may be near an active voltage source (such as an AC source) or other hazard; (b) improving sensitivity and reducing false alarms when detecting active voltage sources; and (c) improving power management of the alert device to improve battery life.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A detection system, comprising:
a housing configured to be worn by a user or carried on a mobile device;
at least one sensing circuit selectively coupled to the housing that is configured to sense or detect a characteristic that includes one or more of electromagnetic radiation, ionizing radiation, a determined liquid analyte, a determined gaseous analyte, a determined powdered analyte concentration, a level of oxygen below a determine threshold value, a data signal strength, a determined level of magnetic flux, a temperature, or a pressure;
at least one communication device that is configured to one or more of generate or communicate a signal in response to sensing or detecting of the characteristic by the at least one sensing circuit; and
an interference circuit configured to reduce or eliminate interference by the sensing circuit.

2. The detection system defined in claim 1, further comprising a locating device configured to determine a location of the housing.

3. The detection system defined in claim 2, wherein the sensing circuit is configured to detect at least electromagnetic radiation, and the interference circuit is configured to dissipate an accumulated charge on the sensing circuit to reduce or eliminate electromagnetic interference.

4. The detection system defined in claim 3, further comprising an external receiver configured to receive the signal from the sensing circuit and to turn off voltage at a device in response to receiving the signal.

5. The detection system defined in claim 2, further comprising a backend system that is configured to communicate with the communication device and thereby to at least receive the signal.

6. The detection system defined in claim 5, wherein the communication device is further configured to transmit first location information from the locating device to the backend system, and the backend system is configured to perform an analysis of one or more signals generated by the detection system and, based at least in part on the analysis and based at least in part on location information of other users is further configured to warn the other users of approach of the other users to or toward an area where a hazard was indicated by the analysis, wherein the analysis is based at least in part on a combination of the one or more signals and the first location information.

7. The detection system defined in claim 5, wherein the sensing circuit is configured to detect one or more hazardous or sub-hazardous readings, and the communication device is configured to transmit those readings, and additional information, to the backend system; and
the backend system stores information regarding the one or more hazardous or sub-hazardous readings, and the additional information includes at least the time and location of the one or more hazardous or sub-hazardous readings.

8. The detection system defined in claim 7, wherein the backend system is configured to dispatch maintenance and service workers to an area in response to an indication by the signal that a threshold value of one or more sensed attributes has been achieved or surpassed, and is configured to tailor the dispatched maintenance to the location and equipped based at least in part on the hazardous or sub-hazardous readings that were detected.

9. The detection system defined in claim 7, wherein the sensing circuit is configured to detect one or more hazardous readings, and the communication device is configured to transmit those readings, and additional information, to the backend system, and
the additional information includes at least the location of the one or more hazardous readings and one or more vital signs of a user of the detection system, wherein a change in the vital signs that could indicate distress of such individual initiates a request for aid for such user to be dispatch to a user location.

10. The detection system defined in claim 7, wherein the backend system is configured to monitor location information of a plurality of users, and to predict location movement of users to determine if any of the users are heading towards an area with identified hazardous or sub-hazardous readings.

11. The detection system defined in claim 7, wherein the backend system is configured to generate a heat map of the one or more hazardous or sub-hazardous readings, and based on determined threshold values associated with an area of the heat map to initiate one or more of:
dispatch maintenance and service workers to identify and address a cause of the one or more hazardous or sub-hazardous readings;
monitor one or more locations or vectors of a plurality of detection systems, and to identify users of such detection systems as such users move within a determined distance of the area of the heat map;
change an operation associated with the cause of the one or more hazardous or sub-hazardous readings;
alert such users that a possibility of a hazardous condition exists;
monitor such user's vital signs for a change that could indicate distress of such individual; or
dispatch one or more emergency medical or hazardous material teams to a location of such users.

12. The detection system defined in claim 11, wherein the change in operation comprises one or more of:
switching a lock condition of a door that leads to or from a location corresponding to the area of the heat map;
initiating a ventilation system to seal the location;
initiating the ventilation system to ventilate the location;
de-energizing a circuit in the location; or
initiating a fire suppression system at the location.

13. The detection system defined in claim 1, wherein the interference circuit comprises an electrically dissipative material.

14. The detection system defined in claim 1, wherein the interference circuit is an interference reduction device embedded in the housing and communicatively coupled to one or more microprocessors, the interference reduction device configured to discharge an accumulated charge on an alert device to reduce electromagnetic interference from sources other than a proximate active voltage source.

15. The detection system defined in claim 14, wherein the interference reduction device is configured to discharge an accumulated charge on the alert device to reduce electromagnetic interference generated by the communication device

16. The detection system defined in claim 14, wherein the one or more microprocessors are further configured to cause the interference reduction device to discharge the accumulated charge after a determined period.

17. The detection system defined in claim 1, wherein the at least one sensing circuit has a substantially omnidirectional angular range.

18. The detection system defined in claim 1, further comprising an accelerometer embedded in the housing and configured to:
detect movement of the detection device; and
selectively activate one or more microprocessors based on the detected movement.

19. A method, comprising:
collecting one or more hazardous or sub-hazardous readings;
comparing the one or more hazardous or sub-hazardous readings to an associated set of determined threshold values, and responding to the one or more hazardous or sub-hazardous readings exceeding at least one of the determined threshold values by:
dispatching maintenance and service workers to a location where the one or more hazardous or sub-hazardous readings were generated to identify and address a cause of the one or more hazardous or sub-hazardous readings;
generating a heat map of the one or more hazardous or sub-hazardous readings; and
monitoring one or more locations or vectors of a plurality of users, if any one of such plurality of users moves within a determined distance of an area of the heat map; and
the method also includes one or more of:
dispatching one or more of emergency medical or hazardous material teams to a location of such users;
alerting such users that a possibility of a hazardous condition exists;
monitoring such user's vital signs for a change that could indicate distress of such individual; or
changing an operation associated with the cause of the one or more hazardous or sub-hazardous readings, where changing the operation comprises one or more of:
switching a lock condition of a door that leads to or from a location corresponding to the area of the heat map;
initiating a ventilation system to seal the location;
initiating a ventilation system to ventilate the location;
de-energizing a circuit in the location; or
initiating a fire suppression system at the location.

20. The method as defined in claim 19, wherein the one or more hazardous or sub-hazardous readings comprises detecting proximity of a high voltage source, and further comprising discharging a static charge on a sensing device for detecting proximity of a high voltage source.
